(19) United States
(12) Patent Application Publication
(10) Pub. No.: US 2008/0273547 A1
(43) Pub. Date: Nov. 6, 2008

(54) Apparatus and method for acknowledging successful transmissions in a wireless communication system

(75) Inventor: Thomas L. Phinney, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/799,171

(22) Filed: May 1, 2007

(51) Int. Cl. H04J 3/16

(52) U.S. Cl. 370/437

(57) ABSTRACT

An initiating device in a wireless network transmits a data message to at least three responding devices. None, one, some, or all of the responding devices may successfully receive the data message. Any responding device that successfully receives the data message sends an acknowledgement to the initiating device, which may or may not receive the acknowledgement. The responding devices may use any suitable technique to determine an order in which the acknowledgements are communicated to the initiating device, such as by using an ordering of the network addresses of the responding devices. With adequate spatial and angular separation of the responding devices from the perspective of the initiating device, the likelihood of a lost (unsuccessfully received) data message in the wireless network can be reduced significantly. This may be useful, for example, in industrial process control systems used to control industrial processes.

### TECHNICAL FIELD

This disclosure relates generally to wireless communication systems and more specifically to an apparatus and method for acknowledging successful transmissions in a wireless communication system.

### BACKGROUND

Wireless communication systems routinely suffer from multi-path interference or other noise or interference problems. Multi-path interference occurs when wireless signals traverse multiple paths from a transmitting device to a receiving device. The wireless signals arrive at the receiving device at slightly different times, interfering with one another at the receiving device. This may be a particular problem, for example, in industrial facilities. Industrial facilities often include a large amount of processing equipment that interfere with and create multiple paths for wireless signals. As a result, interference in industrial facilities can often significantly interfere with transmissions from wireless sensors or other wireless devices. Even without any other interference, many wireless communications in an industrial facility or other environment may still suffer a failure rate of 5% or more.

### SUMMARY

This disclosure provides an apparatus and method for acknowledging successful transmissions in a wireless communication system.

In a first embodiment, a method includes receiving a data message from a wireless initiating device at a first responding device. The initiating device communicates the data message to at least two other responding devices. The method also includes determining a transmit time for communicating an acknowledgement message to the initiating device. The transmit time is determined so as to not interfere with any communications of other acknowledgement messages by the at least two other responding devices. In addition, the method includes communicating the acknowledgement message to the initiating device at the determined transmit time.

In particular embodiments, the initiating device transmits the data message during a transmit window, and receiving the data message includes opening a receive window that is larger than and that encompasses the transmit window.

In other particular embodiments, a clock skew between each responding device and the initiating device is less than a first threshold. Also, a clock skew between the responding devices is less than a second threshold.

In yet other particular embodiments, determining the transmit time includes determining an order of the communications of the acknowledgement messages by the responding devices. The order of the communications may be based on network addresses of the responding devices. Also, the method may further include identifying the at least two other responding devices based on a multicast group identified in the data message. The multicast group identifies the responding devices that interact with the initiating device.

In still other particular embodiments, the responding devices represent wireless access points in a wireless network.

In a second embodiment, an apparatus includes a transceiver configured to receive a data message from an initiating device. The initiating device is configured to communicate the data message to the apparatus and to at least two other responding devices. The apparatus also includes a controller configured to determine a transmit time for communicating an acknowledgement message to the initiating device. The transmit time is determined so as to not interfere with any communications of other acknowledgement messages by the at least two other responding devices. The transceiver is configured to communicate the acknowledgement message to the initiating device at the determined transmit time.

In particular embodiments, the transceiver represents one of a plurality of transceivers. Also, the controller is configured to control the transceivers so that no transceiver is transmitting when at least one transceiver is receiving.

In a third embodiment, a method includes transmitting a data message from an initiating device to at least three responding devices. The method also includes determining whether any acknowledgement messages are received from any of the at least three responding devices. In addition, the method includes re-transmitting the data message when no acknowledgement messages are received from any of the at least three responding devices.

In particular embodiments, determining whether any acknowledgement messages are received includes opening a receive window after a transmit window. The data message is transmitted during the transmit window. A beginning of the receive window is separated from an end of the transmit window by an amount of time no greater than that required for any one of the at least three responding devices to receive the data message, authenticate the data message, prepare the acknowledgement message, and reverse direction from receive to transmit.

In other particular embodiments, the at least three responding devices, from a perspective of the initiating device, are spatially and angularly separated so that electromagnetic propagation paths to and from the initiating device and one of the responding devices is statistically independent from electromagnetic propagation paths to and from the initiating device and another of the responding devices.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to one embodiment of this disclosure;

FIGS. 2 and 3 illustrate an example wireless access point in a process control system according to one embodiment of this disclosure;

FIGS. 4 and 5 illustrate example communication timings in a process control system according to one embodiment of this disclosure;

FIG. 6 illustrates an example method for wireless transmission in a process control system according to one embodiment of this disclosure; and

FIG. 7 illustrates an example method for wireless reception in a process control system according to one embodiment of this disclosure.

### DETAILED DESCRIPTION

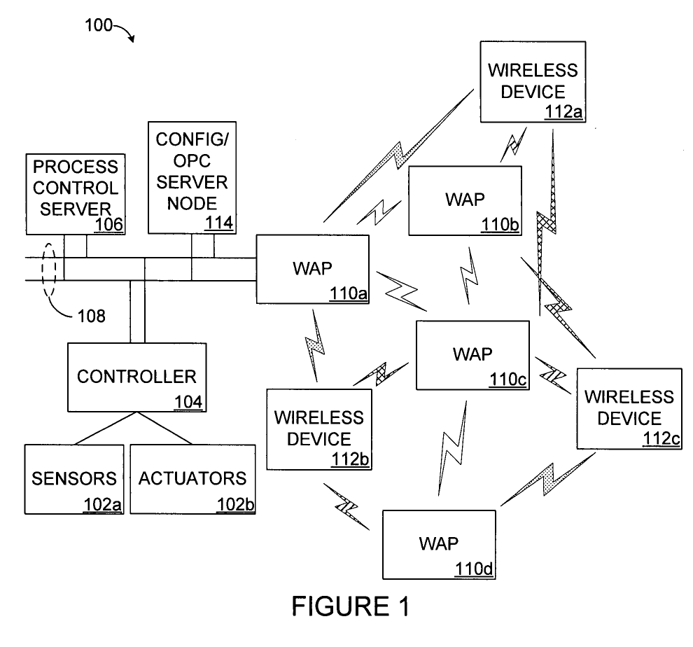

FIG. 1 illustrates an example process control system 100 according to one embodiment of this disclosure. The embodiment of the process control system 100 shown in FIG. 1 is for illustration only. Other embodiments of the process control system 100 may be used without departing from the scope of this disclosure.

In this example embodiment, the system 100 includes various elements that facilitate the processing or production of at least one product or that perform other functions. These elements include one or more sensors 102a and one or more actuators 102b. The sensors 102a and the actuators 102b represent components in a process or production system that may perform any of a wide variety of functions. For example, the sensors 102a could measure a wide variety of characteristics in the system 100, such as temperature, pressure, or flow rate. Also, the actuators 102b can perform a wide variety of operations that alter the characteristics being monitored by the sensors 102a. For instance, the actuators 102b could represent heaters, motors, or valves. The sensors 102a and actuators 102b could represent any other or additional components in any suitable system. Each of the sensors 102a includes any suitable structure for measuring one or more characteristics in a process, production, or other system. Each of the actuators 102b includes any suitable structure for operating on or affecting a change in at least part of a process, production, or other system.

A controller 104 is coupled to the sensors 102a and the actuators 102b. The controller 104 may, among other things, use the measurements from the sensors 102a to control the operation of the actuators 102b. For example, the controller 104 could receive measurement data from the sensors 102a and use the measurement data to generate control signals for the actuators 102b. The controller 104 includes any hardware, software, firmware, or combination thereof for interacting with the sensors 102a and controlling the actuators 102b. The controller 104 could, for example, represent a multivariable controller or other types of controller that implements control logic (such as logic associating sensor measurement data to actuator control signals). As a particular example, the controller 104 could represent a computing device running a real-time operating system.

A process control server 106 communicates with the controller 104. The process control server 106 performs various functions to support the operation and control of the controller 104, the sensors 102a, and the actuators 102b, thereby controlling one or more processes. For example, the process control server 106 could control and adjust the operation of the controller 104, log information collected or generated by the controller 104, and provide secure access to the controller 104. The process control server 106 includes any hardware, software, firmware, or combination thereof for controlling the operation of at least part of the process control system 100. The process control server 106 could, for example, represent a computing device executing a MICROSOFT WINDOWS operating system.

A network 108 facilitates communication between various components in the system 100. For example, the network 108 may communicate Internet Protocol (IP) packets, frame relay frames, Asynchronous Transfer Mode (ATM) cells, or other suitable information between network addresses. The network 108 may include one or more local area networks (LANs) or any other communication system or systems at one or more locations. In particular embodiments, the network 108 may represent a single network or redundant networks, such as one or a pair of Ethernet networks.

As shown in FIG. 1, the process control system 100 also includes a wireless network formed using wireless access points (WAPs) 110a-110d. The wireless access points 110a-110d facilitate communication with and between various wireless devices 112a-112c. For example, each of the wireless access points 110a-110d may receive data (either directly from the network 108 or indirectly through one or more other wireless access points) and forward the data towards one or more of the wireless devices 112a-112c. Each of the wireless access points 110a-110d could also receive data from the wireless devices 112a-112c (either directly or indirectly through one or more other wireless access points) and forward the data towards the network 108. In this way, the wireless access points 110a-110d form a wireless network capable of providing wireless coverage to a specified area, such as in a large industrial complex. Each of the wireless access points 110a-110d includes any suitable structure facilitating wireless communications with and between the wireless devices 112a-112c. In some embodiments, the wireless access points 110a-110d form a mesh network and provide redundant communication paths between the network 108 and the wireless devices 112a-112c.

In this example, the wireless access point 110a may also provide gateway functions for converting data between the protocol(s) used by the network 108 and the protocol(s) used by the wireless access points 110a-110d. For example, the wireless access point 110a could convert Ethernet-formatted data into a wireless protocol format (such as the IEEE 802.11a, 802.11b, 802.11g, 802.11n, 802.15.3, 802.15.4, or 802.16 protocol format) used by the wireless access points 110a-110d. The wireless access point 110a could also convert data received from one or more of the wireless access points 110b-110d into Ethernet-formatted data for transmission over the network 108.

The wireless devices 112a-112c represent fixed or portable devices used in the process control system 100 to perform various functions. For example, the wireless devices 112a-112c could be integrated into or attached to sensors or actuators. The wireless devices 112a-112c could therefore replace, be included within, be associated with, or be separate from the sensors 102a and the actuators 102b. Any other or additional wireless devices 112a-112c could be used in the process control system 100, whatever the function or functions provided by the devices. Each of the wireless devices 112a-112c includes any suitable structure for communicating wirelessly.

A configuration and OLE for Process Control (OPC) server node 114 can be used to configure and control various aspects of the process control system 100. For example, the node 114 could be used by a user to configure the operation of the wireless access points 110a-110d. The configuration and OPC server node 114 could be used to configure or control any other or additional aspects of the process control system 100 or to perform any other suitable functions in the process control system 100. Also, while shown as being coupled to the network 108, the configuration and OPC server node 114 could communicate in any other suitable manner, such as wirelessly via the wireless access points 110a-110d.

In one aspect of operation, each of the wireless devices 112a-112c may transmit data to the wireless access points 110a-110d. The wireless devices 112a-112c and the wireless access points 110a-110d may operate using an Automatic Repeat reQuest (ARQ) protocol. In this protocol, an initiating device (a wireless device 112a-112c) transmits data to a responding device (a wireless access point 110a-110d), which transmits an acknowledgement after a successful receipt of the transmission (such as a receipt without uncorrectable errors). This acknowledgement (often denoted ACK) informs the initiating device that the transmission was received successfully and that re-transmission is not required. If the initiating device does not receive any acknowledgement, the initiating device may retry the transmission at a later time.

To reduce the possibility of failed transmissions in the system 100, each initiating device may communicate directly with at least three responding devices. The three responding devices could include multiple wireless access points 110a-110d and/or multiple transceivers in a single wireless access point 110a-110d. Ideally, when viewed from an initiating device, the three responding devices are located so that they have significant spatial separation and significant angular separation. In this case, electromagnetic propagation paths to and from the initiating device and one responding device may be statistically independent from those between the initiating device and another responding device. Also, in-band energy sources that might interfere with one intended responding device's ability to receive a transmission, due to their proximity to the intended responding device, may be sufficiently distant from other intended responding devices so that the other responding devices do not suffer from the same interference.

In particular embodiments, each wireless device 112a-112c has primary, secondary, and tertiary destinations for communications. These different relationships are illustrated in FIG. 1 using “zig-zag” indicators to represent wireless communications. Communications between the wireless access points 110a-110d (such as within a mesh wireless network) are shown using clear indicators. Each wireless device 112a-112c also communicates with three responding devices. In FIG. 1, hatched indicators represent communications between a wireless device and its primary responding device, cross-hatched indicators represent communications between a wireless device and its secondary responding device, and dotted indicators represent communications between a wireless device and its tertiary responding device. For example, the wireless device 112a communicates with its primary responding device (the wireless access point 110b), its secondary responding device (the wireless access point 110c), and its tertiary responding device (the wireless access point 110a).

The reception of a single data transmission by N responding devices at diverse locations has the potential to reduce the single-receiver failure rate in the system 100 to the N^{th} power. For example, if the possibility of a single responding device not receiving a data transmission is 5% (0.05), the possibility of three responding devices not receiving the data transmission may be 0.0125% (0.05³). When the failure rate is much higher than 5% (such as when significant interference exists), the same power law reduction can occur when the susceptibility of each responding device to the interference is statistically independent. When the interference affects multiple diverse responding devices (but the effects are unequal), a benefit less than the N^{th} power of the failure rate (but still appreciably better than that for a single responding device) can be obtained. For instance, assume Prob_{U} represents the probability of a single responding device not receiving a transmission due to uncorrelated noise or interference. Also, assume Prob_{C} represents the probability of a single responding device not receiving a transmission due to correlated noise that affects all intended responding devices. The probability that a transmitted message is not received correctly by any of the intended responding devices is approximately Prob_{C}+(Prob_{U})^{N}. Related statistics involving binomial or multinomial expansions may hold when the probability of correlated interference differs for each pairing or grouping of intended responding devices.

In some embodiments, N responding devices that receive a transmission by a wireless device 112a-112c respond to the transmission by sending acknowledgements in a predefined or specified order. For example, each responding device could have a network address, and the responding devices could respond to the wireless device in order of increasing or decreasing network address value.

Although FIG. 1 illustrates one example of a process control system 100, various changes may be made to FIG. 1. For example, the process control system 100 could include any number of each individual component. Also, the functional division shown in FIG. 1 is for illustration only. Various components in FIG. 1 could be combined or omitted and additional components could be added according to particular needs. In addition, FIG. 1 illustrates one operational environment in which the use of multiple acknowledgements can be provided to a wireless initiating device. This functionality could be used in any other or additional process control or non-process control system.

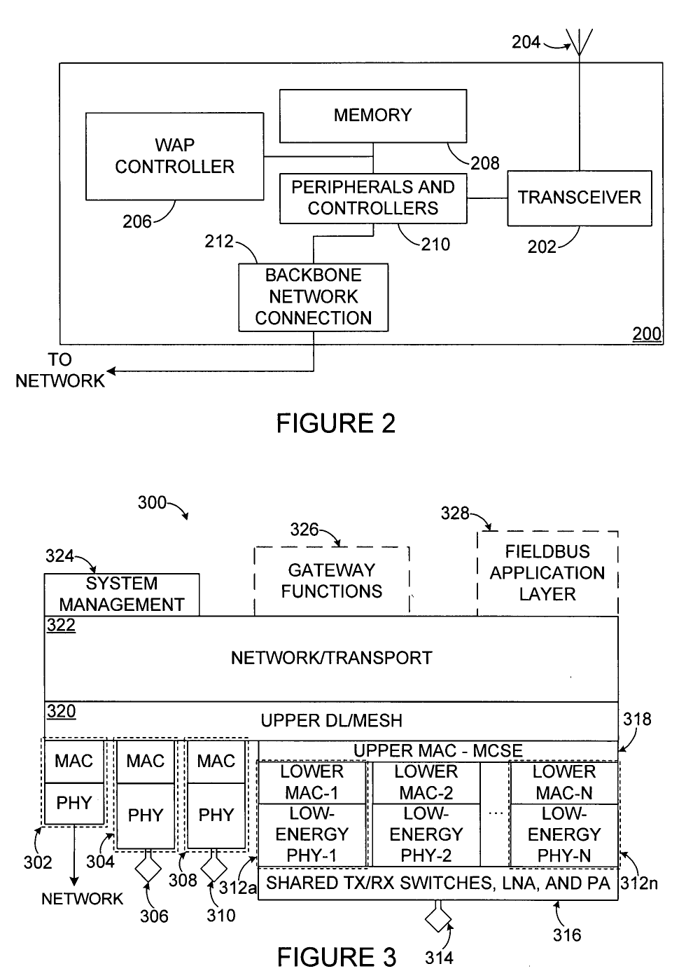

FIGS. 2 and 3 illustrate an example wireless access point in a process control system according to one embodiment of this disclosure. The wireless access point could, for example, be used as one or more of the wireless access points 110a-110d in the process control system 100 of FIG. 1. The embodiment of the wireless access point shown in FIGS. 2 and 3 is for illustration only. Other embodiments of the wireless access point may be used without departing from the scope of this disclosure. Also, for ease of explanation, the wireless access point of FIGS. 2 and 3 is described as being used in the process control system 100 of FIG. 1. The wireless access point could be used in any other suitable process control or non-process control system.

As shown in FIG. 2, a wireless access point 200 includes one or more transceivers 202. Each transceiver 202 facilitates wireless communications to and from the wireless access point 200. For example, a transceiver 202 could receive a baseband or intermediate data signal and modulate the signal onto a carrier signal for transmission by an antenna 204. The transceiver 202 could also receive a carrier signal from the antenna 204 and down-convert the signal into a baseband or intermediate signal. The transceiver 202 includes any suitable structure for transmitting and/or receiving wireless signals. In some embodiments, the transceiver 202 represents a radio frequency (RF) transceiver, and the antenna 204 represents an RF antenna. The transceiver 202 could use any other suitable wireless signals to communicate, such as optical signals.

The wireless access point 200 also includes a controller 206. The controller 206 controls the overall operation of the wireless access point 200. For example, the controller 206 may receive or generate data to be transmitted externally, and the controller 206 could provide the data to the transceiver 202 for wireless transmission. The controller 206 could also receive data from the transceiver 202 that was transmitted to the wireless access point 200 and use the data. As a particular example, the controller 206 could receive data transmitted by a wireless device 112a-112c and cause the transceiver 202 to transmit an acknowledgement message to the wireless device. The controller 206 could also determine the appropriate time for communicating the acknowledgement message to the wireless device, such as to avoid collisions with possible transmissions of other acknowledgement messages by other wireless access points. The controller 206 includes any suitable hardware, software, firmware, or combination thereof for controlling operation of the wireless access point 200. As particular examples, the controller 206 could represent a processor, microprocessor, microcontroller, field programmable gate array (FPGA), or other processing or control device.

A memory 208 is coupled to the controller 206. The memory 208 stores any of a wide variety of information used, collected, or generated by the wireless access point 200. For example, the memory 208 could store instructions executed by the controller 206 and data used, collected, or generated by the controller 206. As a particular example, the memory 208 could store data being transmitted by the transceiver 202 or data received by the transceiver 202. The memory 208 includes any suitable volatile and/or non-volatile storage and retrieval device or devices.

In addition, the wireless access point 200 includes various peripherals and controllers 210 and one or more backbone network connections 212. The peripherals and controllers 210 support various functions in the wireless access point 200. For example, the peripherals and controllers 210 could include drivers or other interfaces between the controller 206 and the transceiver 202 or the backbone network connections 212. Each backbone network connection 212 represents an interface to a wired or wireless network, such as the network 108 or a link to other wireless access points. If physically wired to the backbone network, the wireless access point 200 could be coupled to the backbone network through an intermediate device, such as a HART or FOUNDATION FIELDBUS marshalling panel. The peripherals and controllers 210 include any suitable hardware, software, firmware, or combination thereof for performing any suitable desired function in the wireless access point 200. Each backbone network connection 212 represents any suitable structure, such as a wired or wireless transceiver, facilitating communication over a network or other wired or wireless connection.

A notational structure 300 of a wireless access point is shown in FIG. 3. The notational structure 300 shown in FIG. 3 could, for example, represent the logical structure of a specific implementation of the wireless access point 200 of FIG. 2.

As shown in FIG. 3, the wireless access point supports both low-energy communications (such as with low-power field instruments in an industrial facility) and standard wireless communications with wireless devices. The wireless access point also supports the exchange of information with a remote marshalling area or other device or system by a separate wired or wireless backbone network.

In the illustrated embodiment, the wireless access point includes multiple transceivers, where each transceiver includes or supports a physical layer (PHY) and a Medium Access Control (MAC) layer. In this example, a transceiver 302 supports communication over a wired backbone network. The transceiver 302 could, for example, include IEEE 802.3 MAC and PHY layers. Similarly, a transceiver 304 supports communication over a wireless backbone network via an antenna 306. The transceiver 304 could, for example, include an IEEE 802.11 MAC layer and an IEEE 802.11a/g PHY layer. A transceiver 308 and an antenna 310 support low-power communications with wireless fidelity (WiFi) field devices, such as WiFi field equipment or WiFi-enabled mobile telephones. The transceiver 308 could, for example, include an IEEE 802.11 MAC layer and an IEEE 802.11a/b/g PHY layer.

The wireless access point also supports one or multiple transceivers 312a-312n to communicate with various wireless devices (such as wireless devices 112a-112c) in a wireless network. Each of the transceivers 312a-312n includes a lower MAC layer and a low-power/low-energy physical layer. The transceivers 312a-312n in this example share a common antenna 314 and a common front-end 316 (although each transceiver could have its own antenna and/or front-end). The common front-end 316 could include transmit/receive switches (for controlling whether data is transmitted or received over the antenna 314), a low noise amplifier (LNA) for amplifying incoming signals, and a power amplifier (PA) for amplifying outgoing signals. Here, the lower MAC layer in each transceiver 312a-312n manages the detailed timing of a single transaction, such as the receipt of a transmission from a wireless device and the communication of an acknowledgement message to the wireless device. A shared upper MAC layer 318 manages the transceivers 312a-312n and schedules the activities of the transceivers 312a-312n, such as by identifying the respective channels at which the transceivers 312a-312n operate for any given period of time and the specific communication tasks to which they are assigned.

An upper data link (DL)/mesh layer supports the relaying of information between the various transceivers in the wireless access point. This could include, for example, relaying information between transceivers used for wireless device communications and a backbone network. As a particular example, the mesh could be based on the wireless mesh under development in IEEE P802.11n.

A network/transport layer 322 supports message routing and transport. The network/transport layer 322 could, for example, support standard TCP/IP and ISA SP100-optimized forms of message routing and transport. A system management entity 324 manages the overall operation of the wireless access point. Protocol gateway functions 326 provide optional gateway functions between field and backbone communications, such as a FIELDBUS application proxy, a security proxy, or a network management proxy. In addition, a local FIELDBUS application layer 328 may support various execution functions for FIELDBUS applications, such as by supporting function blocks of various types for providing “control in the field.”

A wireless access point having this notational structure 300 could operate in any suitable manner, such as by supporting time-division multiple access (TDMA) communications. Moreover, the wireless access point could be used in a system that supports any suitable system model, such as the ISA SP100.11a model where information flows predominantly from field instruments to higher-level processing centers (such as asset management systems, distributed control systems, and programmable logic controllers).

To support the use of multiple transceivers 312a-312n, various steps may be taken to ensure communications can occur properly. For example, a transmitting transceiver may interfere with receiving transceivers. As a result, the transceivers 312a-312n can be isolated from each other in an EMI/RFI sense, such as through their power supply and ground plane connections. Also, the antennas can be placed at a specified distance (such as one meter or more) from each other. In addition, the lower MAC layers in the transceivers 312a-312n could be constructed so that no transceiver transmits while another transceiver needs to receive. In this case, the isolation issues may diminish, and the sharing of an antenna 314 and the front-end 316 can be done to reduce the cost of the wireless access point.

Although FIGS. 2 and 3 illustrate one example of a wireless access point in a process control system, various changes may be made to FIGS. 2 and 3. For example, various components in FIG. 2 could be combined or omitted and additional components could be added according to particular needs. As a particular example, the controller 206, memory 208, and peripherals and controllers 210 could form a single microcontroller or other processing device. Also, various transceivers shown in FIG. 3 could be combined or omitted (such as by omitting the transceiver for a wired backbone network when the wireless access point is used with a wireless backbone network). In addition, while FIG. 2 has been described as illustrating a wireless access point, the wireless devices 112a-112c in FIG. 1 could have a similar structure. As a particular example, the network connection 212 could be omitted from the wireless devices 112a-112c unless the network connection 212 could be useful (such as for local-device interconnect).

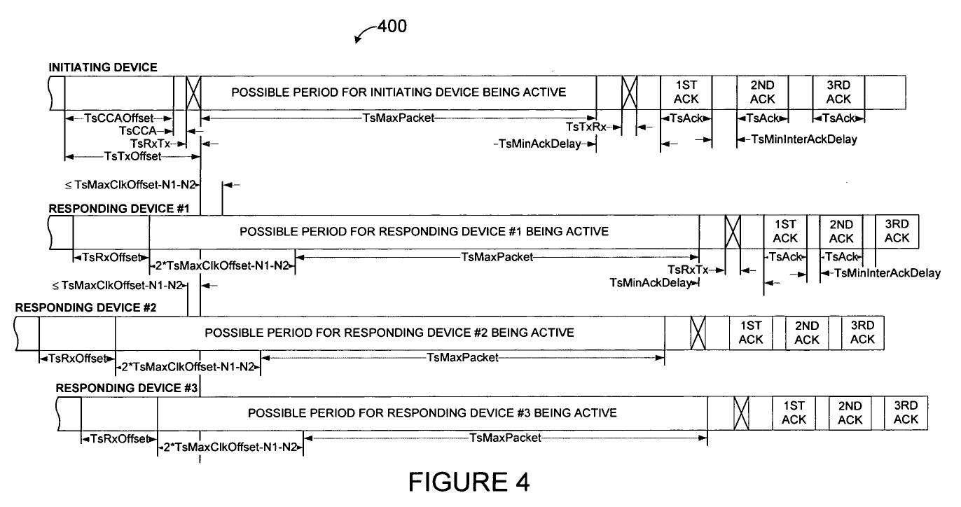

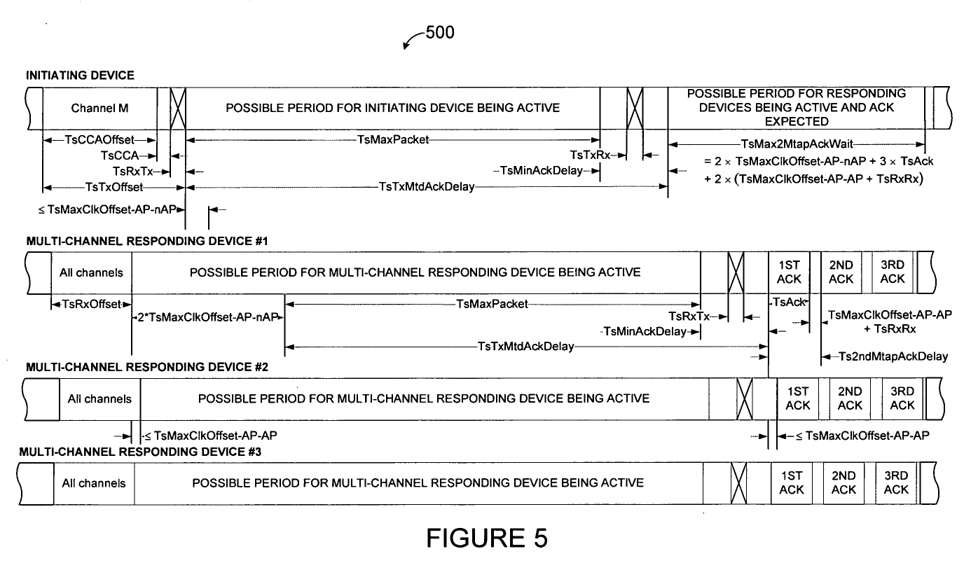

FIGS. 4 and 5 illustrate example communication timings in a process control system according to one embodiment of this disclosure. In particular, FIGS. 4 and 5 illustrate example communication timings involving an initiating device transmitting signals to three responding devices. The embodiments of the timings shown in FIGS. 4 and 5 are for illustration only. Other communication timings may be used without departing from the scope of this disclosure. Also, for ease of explanation, the timings of FIGS. 4 and 5 are described with respect to the process control system 100 of FIG. 1. The timings could be used in any other suitable process control or non-process control system.

In FIGS. 4 and 5, it is assumed that the wireless access points 110a-110d and the wireless devices 112a-112c operate using a TDMA structure having minimal-duration time slots. Moreover, it is assumed that all of these devices share a similar sense of time. This may simplify MAC analysis, scheduling, and transaction processing. It may also help to minimize the impact of any self-interference from separate parts of the overall system by ensuring that this interference disrupts one time slot at most (rather than overlapping two time slots and disrupting both scheduled activities).

With these types of assumptions regarding the system 100, the following paradigm can be implemented. For each transceiver in a device and each time slot, the upper MAC layer in the device selects at most one transaction for execution in a specified channel and with a specified known or unknown set of correspondents. One of the lower MAC layers, in conjunction with one of the transceivers, sequences through a progression of reception and transmission intervals (along with intervals of transceiver non-use) to execute the various phases of a transaction.

Clock skew among the devices participating in a transaction may be caused by drift due to time source imperfections, quantization effects, delays in physical and software paths used for timing synchronization, environmental differences (such as temperature, voltage, and crystal mass changes due to age), or other causes. This clock skew can be taken into account in each type of transaction by coordinating the timing of the various receive and transmit activities in each slot. This may help to ensure that responding devices are ready when a transmission begins.

As described above, the use of three or more responding devices for each transmission may help to significantly reduce data loss in the system 100. In these embodiments, the transmissions may be said to represent multicast transmissions, where the initiating device expects to receive multiple immediate replies from multiple intended responding devices. Without any interference or other problems, the initiating device transmits its data message and receives an acknowledgement from each intended responding device. When interference or other problems exist, the initiating device transmits its data message and may receive an acknowledgement from less than all intended responding devices. The initiating device need not re-transmit the data message if it receives at least one acknowledgement that an intended responding device received the data message.

In the following description of the timings in FIGS. 4 and 5, the symbolic values provided in Table 1 may be used. These symbolic values represent various times required or allotted for various activities during a transaction.

TABLE 1

| | |
|---|---|
| Values | Definitions and Constraints |

Transceiver values

| | |
|---|---|
| TsChTx | Maximum time to select a channel and begin |
| | transmission |
| TsChRx | Maximum time to select a channel and enable |
| | reception |
| TsRxRx | Maximum value of minimum delay between two |
| | successive same-channel receptions |
| TsTxRx | Maximum value of minimum delay between same-channel |
| | transmission and reception |
| TsRxTx | Maximum value of minimum delay between same-channel |
| | reception and transmission |
| TsCCA | Maximum value of minimum time for clear-channel |
| | assessment |

MAC values

| | |
|---|---|
| TsMaxPacket | Transmission duration of a maximum-length non-ACK |
| | packet (such as a data packet or other MAC packet) |
| TsACK | Transmission duration of a maximum-length ACK |
| | packet |

MAC + Transceiver
Values

| | |
|---|---|
| TsRxOffset | Delay from start of time slot to enabling of |
| | reception (≧TsChRx) |
| TsCCAOffset | Delay from start of time slot to start of clear- |
| | channel assessment (≧TsChRx) |
| TsTxOffset | Delay from start of time slot to start of |
| | transmission (max(TsChRx + TsCCA + TsRxTx, TsChTx) when |
| | clear-channel assessment is used or |
| | max(TsChRx, TsChTx) when clear-channel assessment is |
| | not used) |
| TsMinAckDelay | Maximum time to authenticate received message, |
| | prepare an ACK, and reverse transceiver direction |
| | (≧max(TsRxTx, TsTxRx)) |
| TsMinInterAckDelay | Interval between end of reception of one ACK and |
| | start of another ACK for a minimal-duration |
| | multicast (≧TsRxRx) |
| TsTxMtdAckDelay | Interval between start of transmission and delayed |
| | start of first ACK sent by a multi-transceiver |
| | device (MTD) in response, as required for MTDs |
| | (TsMaxPacket + TMinAckDelay) |
| TsRxMtdAckDelay | Interval between MTD enabling reception and delayed |
| | start of first ACK sent in response, as required |
| | for MTDs (2 * TsMaxClkOffset-AP-nAP + TsTxMtdAckDelay) |
| TsMaxAckWait | Maximum time during which a unicast transaction |
| | initiator is able to receive an ACK response |
| | (2 * TsMaxClkOffset-AP-nAP + TsAck) |
| TsMtapInterAckDelay | Interval between start of successive ACK |
| | transmission subslots in a multicast pair of ACK |
| | responses by multi-transceiver access points |
| | (MTAPs) (TsAck + TsMaxClkOffset-AP-AP + TsRxRx) |
| Ts2ndMtapAckDelay | TsMtapInterAckDelay + TsAck |
| TsRxMtap2ndAckDelay | Interval between access point enabling reception |
| | and start of second ACK sent in response, as |
| | required for MTAPs supporting multicast |
| | (TsRxMtdAckDelay + TsMtapInterAckDelay) |
| TsMax2MtapAckWait | Maximum time during which a multicast transaction |
| | initiator is able to receive multiple ACK responses |
| | from access points (for duocast, |
| | 2 * TsMaxClkOffset-AP-nAP + 2 * TsAck + TsRxRx + |
| | TsMaxClkOffset-AP-AP = TsMaxAckWait + Ts2ndMtapAckDelay) |
| Clock drift values | |
| TsMaxClkOffset-N1-N2 | Maximum permitted clock drift between different |
| | types of nodes (such as access points and non- |
| | access points) |
| TsMaxClkOffset-nAP- | Maximum permitted clock drift between nodes that |
| nAP | are not access points |
| TsMaxClkOffset-AP- | Maximum permitted clock drift between an access |
| nAP, | point and a node that is not an access point |
| TsMaxClkOffset-nAP-AP | (<TsMaxClkOffset-nAP-nAP) |
| TsMaxClkOffset-AP-AP | Maximum permitted clock drift between access points |
| | (<TsMaxClkOffset-AP-nAP) |
| Minimum slot duration | |
| TsMin0AckSlotDuration | Minimum duration of time slot that satisfies all |
| | multicasts without ACK constraints |
| | (max(TsRxOffset, TsTxOffset) + 2 * TsMaxClkOffset-N1- |
| | N2 + TsMaxPacket) |
| TsMin1AckSlotDuration | Minimum duration of time slot that satisfies all |
| | unicasts with ACK constraints |
| | (max(TsRxOffset, TsTxOffset) + TsTxMapAckDelay + TsMaxAckWait) |
| TsMin2AckSlotDuration | Minimum duration of time slot that satisfies all |
| | multicasts with multiple ACK constraints |
| | (for duocast, max(TsRxOffset, TsTxOffset) + TsTxMapAckDelay + |
| | TsMax2AckWait = TsMin1AckSlotDuration + TsAck + TsRxRx + |
| | TsMaxClkOffset-AP-AP) |

The timing diagrams in FIGS. 4 and 5 illustrate a slot timing that may reduce or minimize a period starting at the time that a transceiver is first used during a time slot and ending at the transceiver's last use during that time slot. This can be achieved by sending any required acknowledgements as soon as permitted after the end of a packet transmission (which occurs during the initial part of the time slot). This timing may reduce or minimize the energy requirements of both a transceiver and its controller, for example, by permitting either or both to enter a low-power state as soon as possible.

The basic approach used for synchronizing an initiating device with its intended responding devices is for the responding devices to enable reception before the initiating device begins its transmission. For this to occur reliably, the maximum clock skew or drift between the initiating device and its intended responding devices can be bounded. In general, this skew is determined by the inherent drift of the initiating device's clock and the intended responding devices' clocks, as well as the frequency with which they are synchronized to each other or to a common clock source (possibly transitively via multiple hops). Within these figures, the maximum skew is labeled TsMaxClkOffset-N1-N2 for generic timing between different types of devices (such as between an access point and a non-access point). The maximum skew can also be labeled TsMaxClkOffset-AP-AP (for two access points), TsMaxClkOffset-AP-nAP (for an access point and a non-access point), or TsMaxClkOffset-nAP-nAP (for two non-access points).

In FIG. 4, a timing diagram 400 illustrates the timing of a transaction involving an initiating device (such as a wireless device 112a-112c) and three responding devices (such as multiple wireless access points 110a-110d). In this timing diagram 400, it is assumed that each responding device includes a single transceiver.

In FIG. 4, the first line is associated with the initiating device and shows the structure of a generic packet transmission followed by three expected MAC-layer acknowledgements. As shown here, there is a period of delay (TsTxOffset) between the beginning of a time slot and a transmit window at the initiating device. This delay includes a delay from the start of the time slot to the start of an optional clear-channel assessment (TsCCAOffset), the time for performing the optional clear-channel assessment (TsCCA), and the minimum delay between same-channel reception and transmission (TsRxTx). After this period, the initiating device can be active for a period of time (TsMaxPacket) during its transmit window and is free to transmit a non-ACK packet.

Once the initiating device has transmitted the packet, there is a time period (TsMinAckDelay) provided for allowing the intended responding devices to perform various functions. During this time, there is a period (TsTxRx) representing the initiating device's delay between same-channel transmission and reception.

After the TsMinAckDelay period has elapsed, there are three periods during which the initiating device can receive three ACKs from the three intended responding devices. Each of these periods (TsACK) represents the duration of a single ACK packet. Each of these TsACK periods is separated from other TsACK periods by a time interval (TsMinInterAckDelay) that accounts for timing differences between the responding devices and that provides for re-enabling one reception after another.

The second, third, and fourth lines in FIG. 4 show potential timings of three different responding devices relative to the initiating device. For each of the three responding devices, there is a delay (TsRxOffset) from the start of the time slot to the enabling of reception. There is also a period (2*TsMaxClkOffset-N1−N2) which is used to ensure that a responding device that does not have a clock skew larger than a threshold clock skew (TsMaxClkOffset-N1-N2) is receiving when the transmission commences. The responding device has a longer receive window (compared to the transmit window) during which it is active and can receive the transmission from the initiating device. At the end of this period, there is a delay (TsMinAckDelay) where each responding device can authenticate any received message, prepare an ACK, and reverse its transceiver direction. There are then three time periods (TsACK) where each responding device can transmit an ACK message to the initiating device. Any suitable technique could be used to determine the order in which the responding devices transmit the ACKs, such as by transmitting the ACKs in order of increasing network address or in a predefined order.

A similar timing structure can be used when there are more than three responding devices. For example, after a transmission, the initiating device could await four or more ACKs to be received during a time slot. Similarly, four or more responding devices could receive the multicast from the initiating device and transmit ACKs to the initiating device.

In FIG. 5, a timing diagram 500 illustrates the timing of a transaction involving an initiating device (such as a wireless device 112a-112c) and three responding devices (such as one or more wireless access points 110a-110d). In this timing diagram 500, it is assumed that at least one of the responding devices represents a multi-transceiver device (such as a wireless access point having multiple transceivers).

In FIG. 5, the first line is associated with the initiating device and shows the structure of a generic packet transmission on a specific channel. This is followed by a time period for receiving three expected MAC-layer acknowledgements. As shown here, the time periods immediately before and after a packet transmission are similar to those shown in FIG. 4. In FIG. 5, the entire time between the start of the transmit window and the start of a receive window for receiving ACKs is denoted TsTxMtdAckDelay. During the receive window, the initiating device waits for a specified period of time (TsMax2MtapAckWait) to receive one or more acknowledgements from the intended responding devices.

The second, third, and fourth lines in FIG. 5 show potential timings of three different responding devices relative to the initiating device. For each responding device, there is a period (2*TsMaxClkOffset-AP-nAP) used to ensure that a responding device that does not have a clock skew (with respect to the initiating device) larger than a threshold clock skew is actively receiving when the transmission commences. There is also a period (TsMaxClkOffset-AP-AP) used to bound the maximum permitted clock skew of multiple transceivers in different access points (with respect to each other).

For each responding device, after a specified period (TsMinAckDelay), there are three periods (TsACK) when each responding device can transmit an ACK message to the initiating device. Here, the time period between ACKs is defined as the sum of the maximum clock skew between access points (TsMaxClkOffset-AP-AP) and the time required between same-channel receptions (TsRxRx).

As with FIG. 4, a similar timing structure can be used when there are more than three responding devices. For example, after a transmission, the initiating device could open a receive window sufficient for receiving four or more ACKs. Similarly, four or more responding devices could receive the multicast from the initiating device and transmit ACKs to the initiating device.

As noted above, the responding devices in FIGS. 4 and 5 may open their receive windows and prepare for reception before a transmission by the initiating device. The required time period for early turn-on by an intended responding device may be dependent on its maximum clock skew from any initiating device. Also, each initiating device may know in advance an upper bound for that time period. This may allow the initiating device to time-out after non-reception of an acknowledgement. Since prolonged waiting for the reception of an ACK consumes power, a tight upper bound on this time period may reduce or minimize the initiating device's energy expenditure when no ACK is received. Moreover, an upper bound on the maximum clock skew between responding devices may be known in advance by all participants since it can be used to determine the duration of the guard band between ACKs (and therefore the maximum interval for each initiating device that is expecting multiple ACKs).

Although FIGS. 4 and 5 illustrate examples of communication timings in a process control system, various changes may be made to FIGS. 4 and 5. For example, as noted above, more than three responding devices could be used. Also, the timings shown in FIGS. 4 and 5 are for illustration only. Other systems could operate using any other suitable communication timings for communications between various devices.

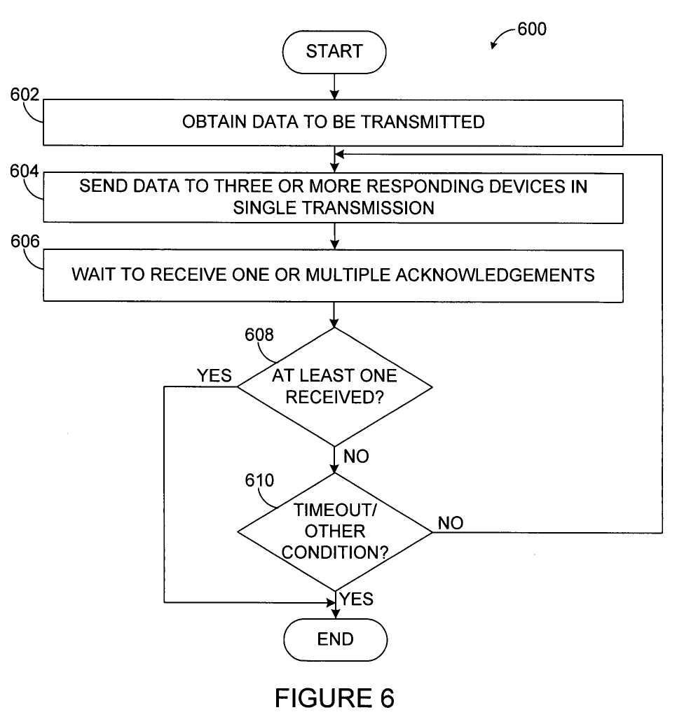

FIG. 6 illustrates an example method 600 for wireless transmission in a process control system according to one embodiment of this disclosure. The method 600 could be used, for example, by a wireless device 112a-112c to transmit data to three or more responding devices, each of which has an associated ACK transmission capability. The embodiment of the method 600 shown in FIG. 6 is for illustration only. Other embodiments of the method 600 may be used without departing from the scope of this disclosure. Also, for ease of explanation, the method 600 is described as being used in the process control system 100 of FIG. 1. The method 600 could be used in any other suitable process control or non-process control system.

An initiating device obtains data to be transmitted at step 602. This could include, for example, a wireless device 112a-112c receiving data from an external source, such as from a user or from another device in the system 100. This could also include the wireless device 112a-112c generating the data to be transmitted.

The initiating device sends the data to three or more responding devices in a single transmission at step 604. This could include, for example, the wireless device 112a-112c transmitting the obtained data. The transmission may include the identity of the three or more intended responding devices, such as their network addresses. The transmission could alternatively identify a multicast group with which the three or more responding devices are associated. The responding devices could be associated with the multicast group by prior role assignment, such as when a multicast group identifies all wireless access points that are intended to interact with the subject wireless device.

The initiating device waits for one or more acknowledgements to be received at step 606. This could include, for example, the wireless device 112a-112c waiting for a period of time sufficient to allow three or more responding devices to receive the transmitted data, authenticate the data, prepare the acknowledgements, reverse their direction, and transmit the acknowledgements.

If no acknowledgements are received at step 608, a determination is made whether a timeout or other condition has occurred at step 610. This could include, for example, the initiating device determining whether a maximum number of transmissions have been performed or whether a maximum time limit has been reached. If not, the method 600 returns to step 604, and the initiating device re-transmits the data. Here, the initiating device has not received any acknowledgements from any responding devices indicating that its prior transmission was received successfully. If at least one acknowledgement is received at step 608, at least one responding device successfully received the transmission and conveyed that status back to the initiating device, and the method 600 ends. The initiating device could then perform any suitable function, such as performing the method 600 again to obtain and transmit additional data. If the timeout or other condition exists at step 610, the method 600 ends, and the initiating device has unsuccessfully attempted to transmit the data. The initiating device could then perform any suitable function, such as entering an error state or attempting to report the error.

Although FIG. 6 illustrates one example of a method 600 for wireless transmission in a process control system, various changes may be made to FIG. 6. For example, the initiating device could obtain data in step 602 that requires multiple packets to send, and the initiating device could repeat steps 604-608 for each packet to be sent. Also, the initiating device could wait for a period of time and re-transmit a packet after transmitting other packets.

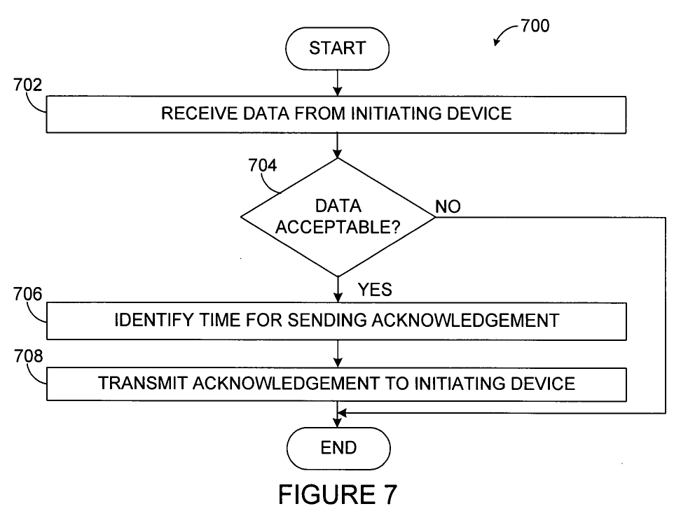

FIG. 7 illustrates an example method 700 for wireless reception in a process control system according to one embodiment of this disclosure. The method 700 could be used, for example, by each of multiple access points 110a-110d to acknowledge data sent by an initiating device. The embodiment of the method 700 shown in FIG. 7 is for illustration only. Other embodiments of the method 700 may be used without departing from the scope of this disclosure. Also, for ease of explanation, the method 700 is described as being used in the process control system 100 of FIG. 1. The method 700 could be used in any other suitable process control or non-process control system.

A responding device receives data from an initiating device at step 702. This could include, for example, an access point 110a-110d opening a receive window that is larger than the amount of time allowed for the transmission of a data packet. This may also include the access point 110a-110d receiving the transmitted data packet during the window.

The responding device determines if the received data is acceptable at step 704. This may include, for example, the access point 110a-110d determining whether the received data contains any uncorrectable errors. If so, the method 700 ends, and no acknowledgement is sent to the initiating device. Ideally, another responding device of the transmitted data successfully receives the data and sends an acknowledgement to the initiating device that the initiating device receives. If not, the initiating device may re-send the data as shown in FIG. 6.

Otherwise, the received data is acceptable, and the responding device identifies a time period for sending an acknowledgement to the initiating device at step 706. This may include, for example, the access point 110a-110d using its network address and the network addresses of other responding devices to determine the order of ACK transmission. The identity of the other responding devices could be determined in any suitable manner, such as by using a multicast group identified in the received data. The responding device then transmits an acknowledgement to the initiating device during the appropriate time at step 708.

Although FIG. 7 illustrates an example method 700 for wireless reception in a process control system, various changes may be made to FIG. 7. For example, rather than using network addresses to determine the acknowledgement transmission order, any other suitable mechanism could be used that reduces or minimizes the likelihood of collisions in the transmissions of the acknowledgements.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc or digital versatile disc (DVD), or any other type of medium.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The term “transceiver” means any device capable of both transmission and reception. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of the invention, as defined by the following claims.

What is claimed is:

1. A method comprising:
receiving a data message from a wireless initiating device at a first responding device, the initiating device communicating the data message to at least two other responding devices;
determining a transmit time for communicating an acknowledgement message to the initiating device, wherein the transmit time is determined so as to not interfere with any communications of other acknowledgement messages by the at least two other responding devices; and
communicating the acknowledgement message to the initiating device at the determined transmit time.

2. The method of claim 1, wherein:
the initiating device transmits the data message during a transmit window; and
receiving the data message comprises opening a receive window that is larger than and that encompasses the transmit window.

3. The method of claim 1, wherein:
a clock skew between each responding device and the initiating device is less than a first threshold; and
a clock skew between the responding devices is less than a second threshold.

4. The method of claim 1, wherein determining the transmit time comprises determining an order of the communications of the acknowledgement messages by the responding devices.

5. The method of claim 4, wherein:
determining the order of the communications of the acknowledgement messages comprises determining the order of the communications based on network addresses of the responding devices; and
the method further comprises identifying the at least two other responding devices based on a multicast group identified in the data message, the multicast group identifying the responding devices that interact with the initiating device.

6. The method of claim 1, further comprising determining whether any uncorrectable errors are present in the data message; and
wherein communicating the acknowledgement message comprises communicating the acknowledgement message when no uncorrectable errors are present in the data message.

7. The method of claim 1, wherein the responding devices comprise wireless access points in a wireless network.

8. An apparatus comprising:
a transceiver configured to receive a data message from an initiating device, the initiating device configured to communicate the data message to the apparatus and to at least two other responding devices; and
a controller configured to determine a transmit time for communicating an acknowledgement message to the initiating device, the transmit time determined so as to not interfere with any communications of other acknowledgement messages by the at least two other responding devices;
wherein the transceiver is configured to communicate the acknowledgement message to the initiating device at the determined transmit time.

9. The apparatus of claim 8, wherein the transceiver is configured to receive the data message during a receive window that is larger than and that encompasses a transmit window of the initiating device.

10. The apparatus of claim 8, wherein:
a clock skew between the apparatus and the initiating device is less than a first threshold; and
a clock skew between the apparatus and each of the at least two other responding devices is less than a second threshold.

11. The apparatus of claim 8, wherein:
the transceiver comprises one of a plurality of transceivers; and
the controller is configured to control the transceivers so that no transceiver is transmitting when at least one transceiver is receiving.

12. The apparatus of claim 11, further comprising:
a single front-end shared by the transceivers; and
a single antenna shared by the transceivers.

13. The apparatus of claim 8, further comprising:
a backbone network interface configured to communicate with a backbone network; and
a second antenna configured to transmit and receive wireless signals in the backbone network.

14. The apparatus of claim 8, wherein the controller is further configured to determine an order of the communications of the acknowledgement messages by the apparatus and the at least two other responding devices.

15. The apparatus of claim 14, wherein:
the controller is configured to determine the order of the communications of the acknowledgement messages based on network addresses of the apparatus and the at least two other responding devices; and
the controller is further configured to identify the at least two other responding devices based on a multicast group identified in the data message.

16. The apparatus of claim 8, wherein:
the apparatus resides in a process control system;
the initiating device comprises a wireless sensor in the process control system; and
the apparatus comprises a wireless access point in a wireless network within the process control system.

17. The apparatus of claim 8, wherein the transceiver comprises a radio frequency transceiver.

18. A method comprising:
transmitting a data message from an initiating device to at least three responding devices;
determining whether any acknowledgement messages are received from any of the at least three responding devices; and
re-transmitting the data message when no acknowledgement messages are received from any of the at least three responding devices.

19. The method of claim 18, wherein:
determining whether any acknowledgement messages are received comprises opening a receive window after a transmit window, the data message being transmitted during the transmit window; and
a beginning of the receive window is separated from an end of the transmit window by an amount of time no greater than that required for any one of the at least three responding devices to receive the data message, authenticate the data message, prepare the acknowledgement message, and reverse direction from receive to transmit.

20. The method of claim 18, wherein the at least three responding devices, from a perspective of the initiating device, are spatially and angularly separated so that electromagnetic propagation paths to and from the initiating device and one of the responding devices is statistically independent from electromagnetic propagation paths to and from the initiating device and another of the responding devices.
